(19) United States
(12) Patent Application Publication
(10) Pub. No.: US 2021/0308777 A1
(43) Pub. Date: Oct. 7, 2021

(54) PANEL SAW

(71) Applicant: Fill Gesellschaft m.b.H., Gurten (AT)

(72) Inventors: Christian BISCHOFBERGER, Andelsbuch (AT); Andreas SUTTERLUETY, Egg (AT)

(73) Assignee: Fill Gesellschaft m.b.H., Gurten (AT)

(21) Appl. No.: 17/262,876

(22) PCT Filed: Jul. 25, 2019
(86) PCT No.: PCT/AT2019/060243

§ 371 Date: Jan. 25, 2021

(30) Foreign Application Priority Data
Jul. 26, 2018 (AT) A50652/2018

(51) Int. Cl. B23D 45/06; B23D 47/00; B23D 47/02; B23D 47/04; B23D 59/00; B23D 59/02; B27B 5/065; B23D 45/00

(52) U.S. Cl. CPC B23D 45/066; B23D 47/005; B23D 47/025; B23D 47/04; B23D 45/003; B23D 59/006; B23D 59/02; B27B 5/065; B23D 59/002

(57) ABSTRACT

The invention relates to a panel saw (1) for cutting plate-shaped workpieces (2) into multiple sections, comprising:
a machine base frame (3);
a workpiece support (4) with a sawing slot (5);
a saw aggregate (7), which is arranged below the workpiece support (4), wherein a circular saw blade (6) is arranged on the saw aggregate (7), which circular saw blade (6) in a sawing position (34) protrudes through the sawing slot (5) and is displaceable in a sawing direction (8);
a holding-down device (9) for clamping the workpiece (2) on the workpiece support (4);
a positioning device (12) for positioning the workpiece (2).

The invention relates to a panel saw for cutting workpieces into multiple sections.

A variety of panel saws is known from DE 102015213359 A1, DE 102006055446 A1, AT 362129 B, DE 102013002879 B3, DE 202010011924 U1, AT 411449 B, DE 202011101665 U1, JPS 6198513 A, EP 0115277 A2, DE 69407213 T2, DE 202012010829 U1 and U.S. Pat. No. 4,635,513 A.

The panel saws known from the prior art have a variety of disadvantages.

The object of the present invention was to overcome the disadvantages of the prior art and to provide a method, by means of which an improved sawing operation can be carried out.

This object is achieved by means of a device and a method according to the claims.

According to the invention, a panel saw is provided for cutting plate-shaped workpieces into multiple sections. The panel saw comprises:
a machine base frame;
a workpiece support with a sawing slot;
a saw aggregate, which is arranged below the workpiece support, wherein a circular saw blade is arranged on the saw aggregate, which circular saw blade in a sawing position protrudes through the sawing slot and is displaceable in a sawing direction;
a holding-down device for clamping the workpiece on the workpiece support;
a positioning device for positioning the workpiece.

Furthermore, it may be useful if the saw aggregate has a rocker, which is mounted on a saw aggregate frame so as to be pivotable about a pivot axis, and that the circular saw blade is mounted on the rocker so as to be rotatable about an axis of rotation at a distance A from the pivot axis, wherein the rocker is arranged, at least in some sections, between a first clamping surface and a second clamping surface, which are coupled to the saw aggregate frame and spaced apart from one another in the axial direction of the pivot axis, and on the rocker, a first counter-clamping surface is formed, which faces the first clamping surface, and a second counter-clamping surface is formed, which faces the second clamping surface, wherein in a pivoted position, the first clamping surface and the first counter-clamping surface, as well as the second clamping surface and the second counter-clamping surface are spaced apart from one another, and in a fixed position, the first clamping surface and the first counter-clamping surface as well as the second clamping surface and the second counter-clamping surface abut on one another. This measure allows the rocker of the saw aggregate to be easily pivotable in the pivoted position, in order to be able to adjust the height of the saw cut and/or a projection of the circular saw blade. Simultaneously, the rocker in the fixed position can be clamped, such that the circular saw blade has an exact positioning and moreover, only few vibrations occur during the cut. Of course, it is also possible for multiple first counter-clamping surfaces and second counter-clamping surfaces to be formed.

Furthermore, it may be provided that the first clamping surface is configured to be stationary relative to the saw aggregate frame, and that the first counter-clamping surface is configured to be stationary relative to the rocker, and that the rocker is configured to be flexible, so that the first counter-clamping surface is movable in the direction toward the first clamping surface and can be pressed against it in the fixed position. In particular, it may be provided in this regard that the rocker has a slight curvature in the pivoted position. This curvature may be triggered for example by means of the tension of a traction means, such as a belt or a chain, which is placed on a drive pinion coupled to the circular saw blade. In the fixed position, the curvature of the rocker can be compensated by being clamped between the two clamping surfaces, and the circular saw blade can be positioned in an exact manner.

Moreover, it may be provided that the second clamping surface is configured to be stationary relative to the saw aggregate frame, and that the second counter-clamping surface is configured to be displaceable relative to the rocker, so that the rocker can be transferred from the pivoted position into the fixed position.

An embodiment, according to which it may be provided that the holding-down device has at least one first holding-down beam with a first holding-down surface, wherein pressure pins, which are displaceable relative to the first holding-down surface, are arranged in the first holding-down beam, is also advantageous. By this measure, it can be achieved that the clamping device can be displaced to the sawing slot as far as possible, in order to be able to cut the smallest possible piece off the workpiece and/or to be able to perform a scrape cut.

In particular, it may be provided that the holding-down beams are divided into individual regions, wherein the pressure pins can be moved out independently of each other in the individual regions. Furthermore, it is also possible that different pressures are applied to the pressure pins in the individual regions.

According to a further embodiment, it is possible that the pressure pins are arranged in bores of the first holding-down surface and are preloaded in their retracted position by means of a spring element, and that the pressure pins are displaceable out of their retracted position and into an advance position by means of compressed air. In particular, it may be provided that the pressure of the compressed air, and thus the pressing force, are adjustable in a variable manner.

Furthermore, it may be useful if the holding-down device has the first holding-down beam with the first holding-down surface and a second holding-down beam with a second holding-down surface, wherein the first holding-down beam is arranged on a first side of the sawing slot and the second holding-down beam is arranged on a second side of the sawing slot, wherein the two holding-down beams are displaceable in the vertical direction both together and independently of one another. By this measure, the workpiece can be clamped independently of one another, either on the first side of the sawing slot or only on the second side of the sawing slot

In particular, it may be provided that the first holding-down beam is driven by an electric motor, in particular a servomotor, and that the second holding-down beam is arranged on the first holding-down beam so as to be displace relative to the first holding-down beam by means of an actuator, in particular of a pneumatic cylinder. The actuator can thus be coupled to the first holding-down beam and the second holding-down beam.

As an alternative thereto, it is of course also conceivable that the second holding-down beam is driven by an electric motor, in particular a servomotor, and that the second holding-down beam is arranged on the first holding-down beam so as to be displace relative to the first holding-down beam by means of an actuator, in particular of a pneumatic cylinder.

Moreover, it may be provided that the workpiece support is formed on a support plate, which rests on a support plate holder, wherein compressed air nozzles protrude through the support plate, wherein the compressed air nozzles have a thread and a mating thread is formed in the support plate holder, and wherein the support plate is affixed to the support plate holder by means of the compressed air nozzles. This measure allows achieving that the support plate does not have to be connected to the support plate holder by means of additional connecting elements. This particularly allows an improvement of the function of the air cushion.

Furthermore, it may be provided that the support plate has through-bores for receiving the compressed air nozzles, and that depressions are formed in said through-bores, wherein the compressed air nozzles have an offset, which corresponds to the depressions, so that the compressed air nozzles are received so as to be recessed in the support plate, and a fixing force can be applied to the support plate by means of the offset of the compressed air nozzles, and additionally, a positioning of the support plate can be achieved. By this measure, a good fixation of the support plate on the support plate holder can be achieved.

According to a particular embodiment, it is possible that an alignment device is formed, which serves to align and/or position the workpiece and optionally simultaneously serves to secure the engagement with the circular saw blade, wherein the alignment device is displaceable in the sawing direction. This measure allows achieving an increased personal safety.

According to an advantageous further embodiment, it may be provided that the alignment device is telescopable in the sawing direction. By this measure, it can be achieved that the alignment device has the largest possible coverage area and simultaneously requires as little space as possible in its rest position.

In particular, it may be advantageous if a suction is arranged in the alignment device. By this measure, it can be achieved that the chips can be suctioned off as best as possible. This is advantageous particularly when performing scrape cuts.

Furthermore, it may be provided for that a stop is arranged on the front sides of the alignment device. The stop may be used for aligning the workpiece with the panel saw.

Moreover, it may be provided that the alignment device is divided, and a first alignment device part is arranged on the first side of the sawing slot and a second alignment device part is arranged on the second side of the sawing slot. In this regard, it is particularly advantageous if the two alignment device parts are displaceable individually and independently of one another. Furthermore, it may be provided that at least the first alignment device part is simultaneously formed as a protective cover. In performing scrape cuts, this measure allows moving one of the two alignment device parts past the workpiece and moving it in a synchronous manner with the saw aggregate. By this measure, the machine safety of the panel saw can be increased, as it can be achieved that at least one of the two alignment device parts can be guided in front of the circular saw blade. Simultaneously, the second alignment device part can serve for aligning the workpiece. Of course, the second alignment device part may also be formed as a protective cover. However, this is not necessarily required as the second side of the sawing slot is usually not accessible to the user.

An embodiment, according to which it may be provided that a circular saw blade lubricating device is formed, which has a nozzle holder having a slot for receiving the circular saw blade, wherein a first lubricant nozzle is arranged in a first lateral wall of the slot and a second lubricant nozzle is arranged in a second lateral wall of the slot, is also advantageous. With the aid of the circular saw blade lubricating device, a lubrication and a cooling of the circular saw blade can be achieved. By means of the described design form of the circular saw blade lubricating device, the turbulences in the region of the lubricant nozzle can be kept to a minimum, which makes an exact application of the lubricant to the circular saw blade possible.

According to a further embodiment, it is possible that the first lubricant nozzle and the second lubricant nozzle are arranged at an angle of 15° to 85° relative to the respective saw blade surface facing them. This measure allows the largest possible region of the circular saw blade to be impinged with lubricant.

Furthermore, it may be provided that the lubricant nozzles, when seen in a lateral view onto the circular saw blade, are inclined downwards at an angle of 5° to 80°, in particular 10° to 45°, from the vertical. The nozzles may be arranged at a fixed height relative to the workpiece support.

Moreover, it may be provided that the lubricant nozzles are displaceable in the horizontal direction. This allows adapting them to different circular saw blade diameters.

Furthermore, it may be provided that the nozzles are actuatable individually and independently of one another. In particular, it may be provided here that only one of the nozzles or multiple nozzles at the same time are impinged on with lubricant. Thereby, the lubrication can be adapted to the requirements of the respective workpiece, in order to use the smallest possible amount of lubricant while achieving the best possible lubrication.

Furthermore, it may be useful if a third lubricant nozzle is arranged at a rear wall of the slot, which lubricant nozzle is directed toward a circumferential surface of the circular saw blade. This entails a surprisingly good lubrication.

Furthermore, it may be provided that the positioning device comprises at least one clamping device, wherein the clamping device comprises a clamping device frame, at least one lower clamping finger, one upper clamping finger and a lever, on which the upper clamping finger is arranged, wherein the lever is mounted on the clamping device frame so as to be pivotable with respect to a first pivot axis, and wherein, between the first pivot axis and the upper clamping finger, a traction/pressure means is coupled to the lever so as to be pivotable with respect to a second pivot axis, wherein the traction/pressure means is coupled to an actuator, in particular a cylinder, such that when extending the actuator, the upper clamping finger is moved toward the lower clamping finger. Particularly when using a pneumatic cylinder or hydraulic cylinder as an actuator, it is advantageous that when extending the actuator, the upper clamping finger is moved toward the lower clamping finger and thus, the clamping device is closed, as a cylinder can apply a greater force when extending than when retracting. Thus, the cylinder may have a smaller dimensioning.

Furthermore, it may be provided that the clamping device has a second lever, which is mounted on the clamping device frame so as to be pivotable about a fourth pivot axis, wherein the second lever at a first longitudinal end is coupled to the actuator and at a second longitudinal end is coupled to the traction/pressure means, and wherein the fourth pivot axis is arranged between the first longitudinal end and the second longitudinal end, in particular that the traction/pressure means is coupled to the second lever such that the traction/pressure means is subjected to tension when the actuator extends.

According to a particular embodiment, it is possible that a detection means is formed, which serves to detect the position of the workpiece in the clamping device. By this measure, it is possible to monitor whether the workpiece is accommodated correctly in the clamping device and thus an exact positioning of the workpiece is made possible by means of the clamping device. In particular, it can be monitored here whether the workpiece is accommodated up to the stop in the clamping device.

According to an advantageous further embodiment, it may be provided that the positioning device comprises a positioning carriage, on which multiple clamping devices are arranged, wherein the positioning carriage is mounted on the machine base frame so as to be displaceable on a first linear guide and on a second linear guide, wherein a first drive motor is coupled to a first drive system in the region of the first linear guide, and a second drive motor is coupled to a second drive system in the region of the second linear guide. By forming two drive motors, the positioning carriage can be exactly controlled in its movement. In particular, when using two drive motors, an exact positioning of the positioning carriage is possible.

Moreover, it may be provided that a fixing element can be provided in the region of the first linear guide and/or the second linear guide, by means of which fixing element the set position can be fixed.

In particular, it can be advantageous if a first absolute measuring system is formed in the region of the first linear guide, which first absolute measuring system serves to provide a position information to the first drive motor, and a second absolute measuring system is formed in the region of the second linear guide, which second absolute measuring system serves to provide a position information to the second drive motor. By using the absolute measuring system, an exact positioning of the positioning carriage can be achieved. In particular, when using one absolute measuring system per linear guide, the positioning carriage can be displaced exactly and in a parallel manner.

Furthermore, it may be provided that the first linear guide and the second linear guide of the positioning carriage are arranged below the level of the workpiece support. By these measures, the two linear guides can be formed solidly and thus robustly, and do not restrict the workpiece with respect to its workability.

Moreover, it may be provided that a vibration damping system is formed on the saw aggregate, which vibration damping system has a force application device for applying force to the circular saw blade in a contactless manner. By this measure, the circular saw blade can run more smoothly, which can improve the cut quality.

An embodiment, according to which it may be provided that the force application device has a fluid nozzle, by means of which a pressure surge can be emitted, in particular by means of compressed air, onto the circular saw blade, or that the force application device has an electromagnet, by means of which a magnetic force impulse can be emitted onto the circular saw blade, is also advantageous. Particularly a fluid nozzle for emitting a compressed air blast is well-suited as a force application device. Alternatively to this, it may also be provided that the fluid nozzle is impinged on by continuous compressed air, in order to apply an air cushion.

Moreover, it may be provided that a light strip, in particular an LED strip, is arranged in the region of the holding-down device. Here, it can be particularly provided that the light strip is arranged on the first side of the panel saw. The light strip can serve to optically transmit information to the machine operator. In particular, the light strip can extend over the entire width of the panel saw. Furthermore, it may be provided that individual light segments, which are arranged next to each other and optionally also in rows on top of each other, are selectively switchable. By this measure, for example the cutting depth of the circular saw blade can be indicated by different numbers of the light segments, which are arranged on top of one another, lighting up depending on the cutting depth. The current position of the circular saw blade can be indicated in that over the width, only those light segments of the light strip light up, in the area of which the circular saw blade is located. Furthermore, it is also conceivable that by means of the light strip, it is signaled whether a machine operator is inside a safety area and/or which regions are defined as safety areas for a method step ongoing at a certain moment.

According to the invention, a method for operating a panel saw is provided, wherein the method comprises the following method steps:
placing a plate-shaped workpiece on the workpiece support;
measuring the workpiece by means of a measuring apparatus;
positioning the workpiece by means of a positioning device;
cutting the workpiece by means of the circular saw blade by displacing the saw aggregate in the sawing direction.

Furthermore, it may be useful if the following method steps are carried out for cutting an end section of the workpiece:
positioning the workpiece by means of the positioning device;
lowering the first holding-down beam;
moving the pressure pins out of the first holding-down surface of the first holding-down beam until the pressure pins press the workpiece onto the workpiece support, wherein particularly the pressure pins between the upper clamping fingers press against the workpiece;
opening the upper clamping finger and/or removing the clamping force of the clamping device of the positioning device;
removing the positioning device from the workpiece;
lowering the first holding-down beam and the second holding-down beam until the first holding-down surface of the first holding-down beam and the second holding-down surface of the second holding-down beam abut on the workpiece;
cutting the workpiece by means of the circular saw blade by displacing the saw aggregate in the sawing direction. These method steps allow achieving that even workpieces, which have a short remaining length, can be clamped in the panel saw.

Moreover, it may be provided that the following method steps are carried out for cutting an start section of the workpiece:
positioning the workpiece by means of the positioning device;
displacing the first alignment device part and the second alignment device part toward the workpiece until the second stop of the second alignment device part contacts the workpiece;
lowering the first holding-down beam and the second holding-down beam until the first holding-down surface of the first holding-down beam and the second holding-down surface of the second holding-down beam abut on the workpiece;
cutting the workpiece by means of the circular saw blade by displacing the saw aggregate in the sawing direction while simultaneously displacing the first alignment device part along with the saw aggregate. By this measure, the machine safety during a scrape cut can be improved.

Furthermore, it may be provided that when cutting the workpiece by means of the circular saw blade, the vibration amplitude of the circular saw blade in the axial direction is detected by a measuring system, and the circular saw blade is subjected to force impacts by the force application device, such that the vibration amplitude of the circular saw blade is counteracted. By this measure, the running smoothness of the circular saw blade can be improved for being able to perform precise and clean cuts. Furthermore, this measure allows using thinner circular saw blades.

Furthermore, it may be provided that when positioning the workpiece by means of the positioning device, the first drive motor and the second drive motor are operated synchronously, wherein the detection value of the first absolute measuring system and of the second absolute measuring system flows into the control as a control variable. This measure allows achieving an exact positioning of the workpiece.

For the purpose of better understanding of the invention, it will be elucidated in more detail by means of the figures below.

These show in a respectively very simplified schematic representation:

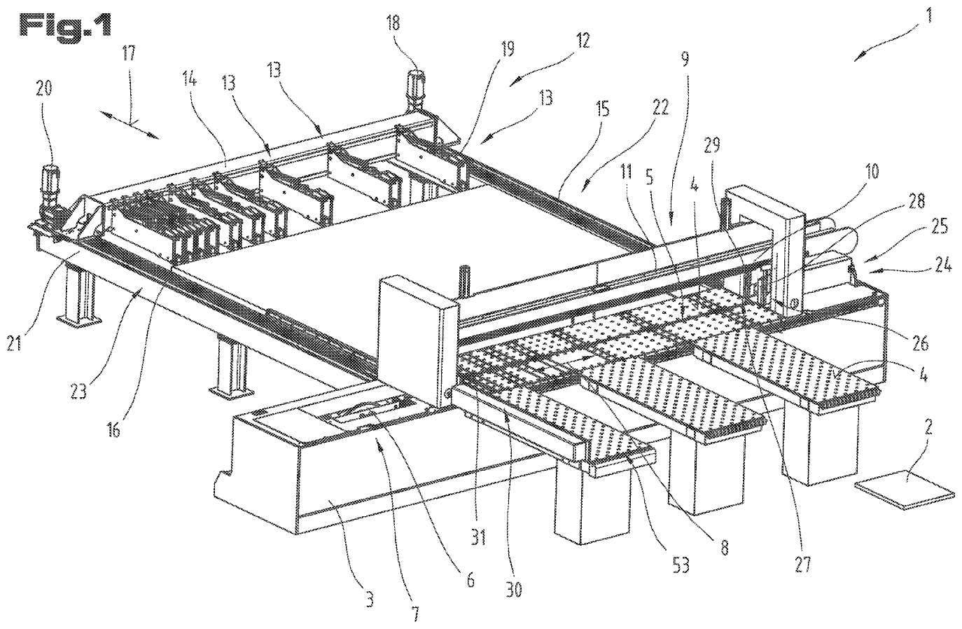

FIG. 1 a perspective view of a panel saw;

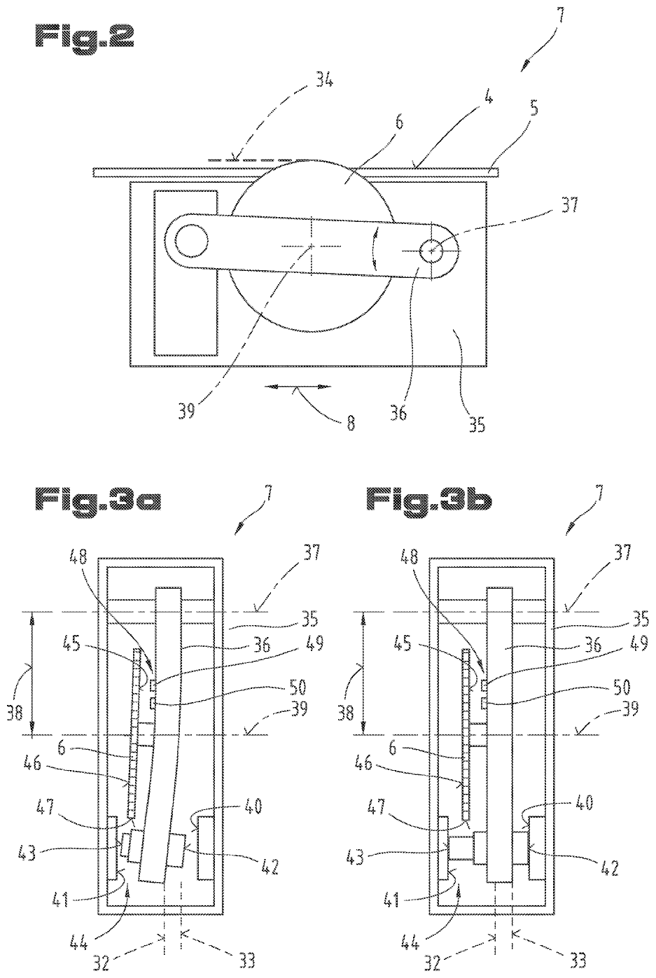

FIG. 2 a lateral view of a saw aggregate of the panel saw;

FIG. 3 a top view of the saw aggregate of the panel saw;

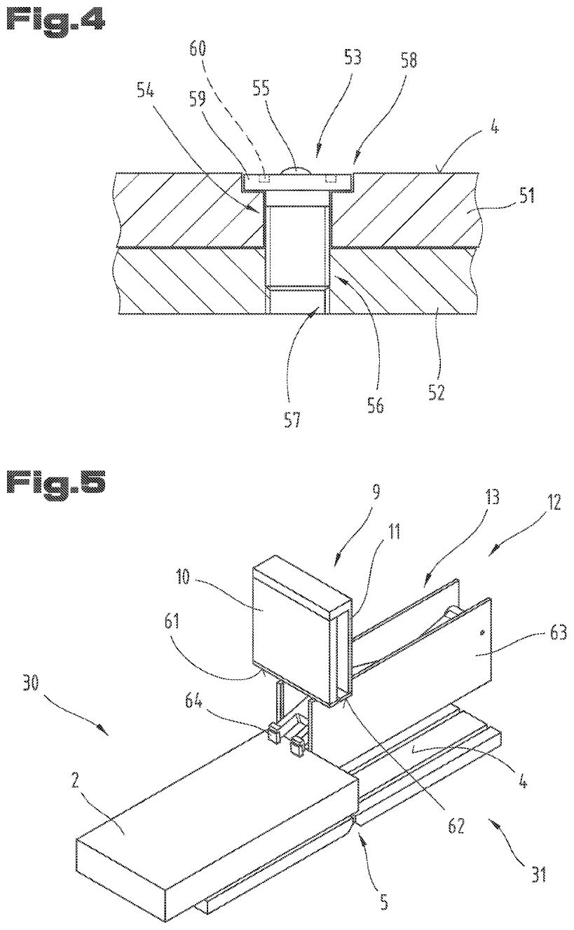

FIG. 4 a sectional view of the screwing of a compressed air nozzle;

FIG. 5 a perspective view of a pressure beam;

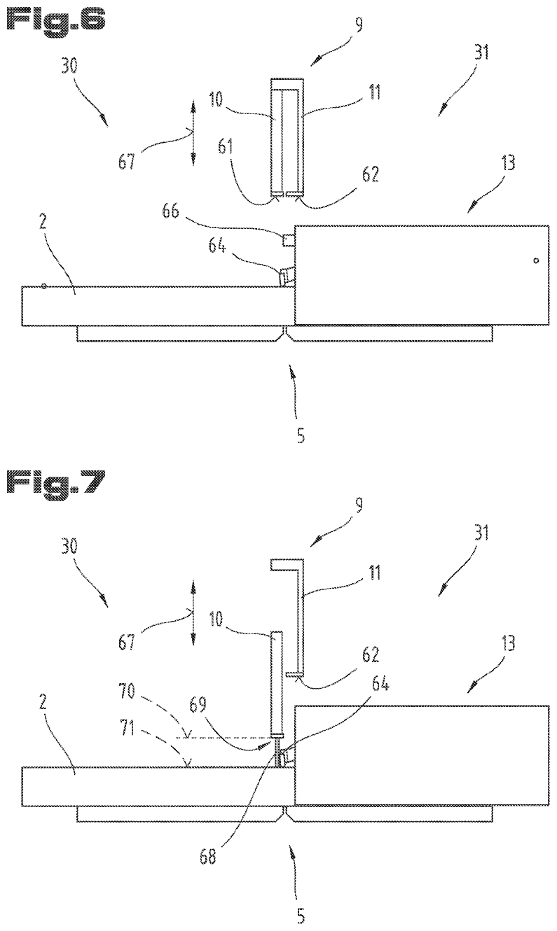

FIG. 6 a first method step for clamping a workpiece;

FIG. 7 a second method step for clamping a workpiece;

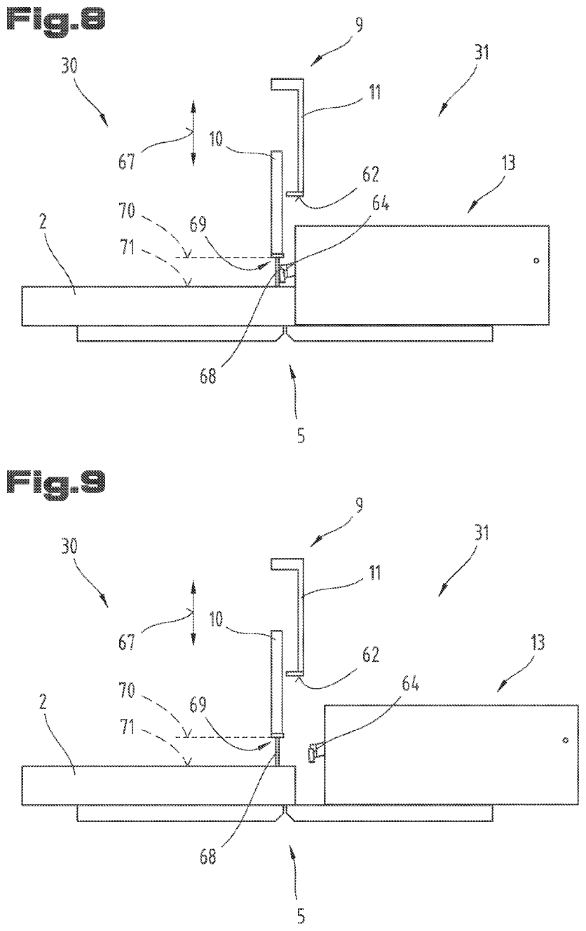

FIG. 8 a third method step for clamping a workpiece;

FIG. 9 a fourth method step for clamping a workpiece;

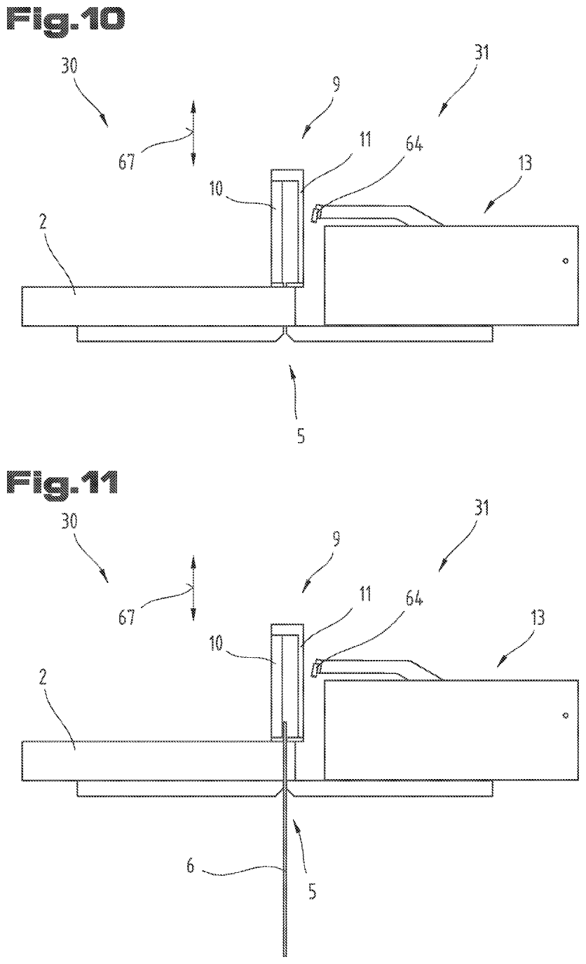

FIG. 10 a fifth method step for clamping a workpiece;

FIG. 11 a sixth method step for clamping a workpiece;

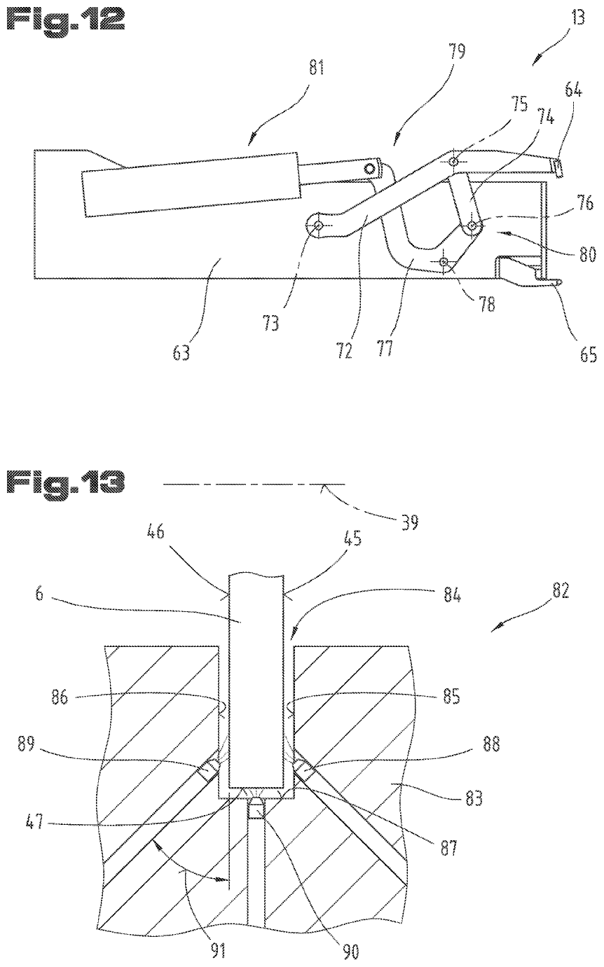

FIG. 12 a perspective view of a clamping device;

FIG. 13 a sectional view of a circular saw blade lubricating device.

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

FIG. 1 shows a perspective view of a panel saw 1 for cutting plate-shaped workpieces 2. By means of the panel saw 1 the plate-shaped workpieces 2 can be divided into multiple sections and/or can be cut to a predefined size.

The panel saw 1 comprises a machine base frame 3, on which the individual components are built-on.

Furthermore, a workpiece support 4 is formed, onto which the workpiece 2 can be placed. In the region of the workpiece support 4 a sawing slot 5 is provided, through which a circular saw blade 6 of a saw aggregate 7 can protrude in order to cut the workpiece 2. The saw aggregate 7 is displaceable in the sawing direction 8, in order to be able to cut the workpiece 2 on a large width of the panel saw 1.

Moreover, a holding-down device 9 is provided, which serves to clamp the workpiece 2 on the workpiece support 4. The workpiece 2 can be clamped for cutting by means of the holding-down device 9, in order to achieve a clean and positionally accurate cut. The holding-down device 9 comprises a first holding-down beam 10 and a second holding-down beam 11. The construction of the holding-down beams 10, 11 is described in more detail below in the FIGS. 6 and 7.

Furthermore, the panel saw 1 comprises a positioning device 12, which serves to position the workpieces 2. The positioning device 12 comprises multiple clamping devices 13, which are arranged on a positioning carriage 14. The clamping devices 13 are described in more detail below in FIG. 12.

As is apparent from FIG. 1, it may be provided that the clamping devices 13 are arranged on the positioning carriage 14 at irregular distances. In particular, it may be provided that on a stop side of the panel saw 1, are arranged at a narrower distance from one another. This helps achieve that even small workpieces 2 can be clamped well by means of the clamping devices 13. Moreover, it may be provided that the clamping devices 13 are arranged on the positioning carriage 14 so as to be displaceable in the sawing direction 8, in order to be able to position them according to the character of the workpiece 2.

As is further apparent from FIG. 1, the positioning device 12 has a first linear guide 15 and a second linear guide 16, by means of which the positioning carriage 14 is displaceable in a positioning direction 17.

Furthermore, a first drive motor 18 is provided in the region of the first linear guide 15, which first drive motor 18 is coupled to a first drive system 19 and serves to displace the positioning carriage 14 in the positioning direction 17. Analogously to this, a second drive motor 20 is formed in the region of the second linear guide 16, which second drive motor 20 is coupled to a second drive system 21 and also serves to displace the positioning carriage 14 in the positioning direction 17.

The first drive system 19 and/or the second drive system 21 can have most diverse drive mechanisms. For example, it is possible that the drive systems 19, 21 are realized by means of a rack and pinion drive, a timing belt drive, a drive spindle, such as a ball screw, or any other power transmission means known from the prior art.

The two drive motors 18, 20 are preferably provided in the form of servomotors, which are operated synchronously to one another. In this regard, the two drive motors 18, 20 can be controlled by a central machine control.

Alternatively to this, it may be provided that the two drive motors 18, 20 are provided in the form of linear drives.

Moreover, a first absolute measuring system 22 is provided, which serves to detect the position of the positioning carriage 14 in the region of the first linear guide 15. Analogously to this, a second absolute measuring system 23 is provided, which serves to detect the absolute position of the positioning carriage 14 in the region of the second linear guide 16. In particular, it is provided that the two absolute measuring systems 22, 23 are used as the input variable in the machine control, in order to specify the exact position of the positioning carriage 14 with the aid of the drive motors 18, 20.

As is evident from FIG. 1, an alignment device 24 is formed, which can cover the circular saw blade 6 during the operation of the panel saw 1, so that the machine operator cannot reach into it. In particular, it may be provided that a suction 25 is formed in the alignment device 24, which suction 25 serves to suction off the chips.

Furthermore, it may be provided that the alignment device 24 has a first alignment device part 26, which is arranged on a first side 30 of the sawing slot 5. In addition, the alignment device 24 may have a second alignment device part 27, which is arranged on a second side 31 of the sawing slot 5. The first alignment device part 26 and the second alignment device part 27 together can form the alignment device 24. In particular, it may be provided that the first alignment device part 26 has a first stop 28 and that the second alignment device part 27 has a second stop 29.

The alignment device parts 26, 27 are displaceable in the sawing direction 8 and are displaced in the sawing direction 8 after positioning the workpiece 2, such that at least one of the two stops 28, 29 comes to abut on the workpiece 2.

If both parts cut out of the workpiece 2 have a great expansion in the positioning direction 17, both the first stop 28 and the second stop 29 come to abut on the workpiece 2.

If, however, a so-called scrape cut is performed, in which only a flat front face is produced on the workpiece 2 and thus, only a strip having about the same width as the saw blade is removed from the workpiece 2, only one of the two stops 28, 29, namely the first stop 28 or the second stop 29 comes to abut on the workpiece 2. If, for example, a scrape cut is performed on a front side of the workpiece 2, the workpiece 2 is preferably clamped by means of the second stop 29. In this regard, the first alignment device part 26 lies outside the region of the workpiece 2 and can thus be displaced in front of the workpiece 2. In particular, it may be provided in this that the first alignment device part 26 is displaced in front of the circular saw blade 6 and, while cutting the workpiece 2, is displaced in the sawing direction 8 simultaneously with the circular saw blade 6, so that the first alignment device part 26 is positioned in front of the circular saw blade 6 over the entire duration of the saw cutting operation and thus protects the machine operator from the circular saw blade 6.

In particular, it may be provided that at least the first alignment device part 26 is telescopable in the sawing direction 8, so that the first alignment device part 26 in a rest position of the alignment device parts 26, 27, as shown in FIG. 1, has the shortest possible extension in the sawing direction 8, in order to use up as little space as possible. If the first alignment device part 26, however, is moved out of its rest position, the extension of the first alignment device part 26 in the sawing direction 8 may become longer due to the telescopability, so that the circular saw blade 6 can be covered as best as possible. In particular, it may be provided that the first alignment device part 26 has two segments, which can be displaced one after the other. The two segments can be pushed apart by means of a spring element, such as a gas compression spring at its maximum extension. When displacing the first alignment device part 26 into the rest position, the rear segment may abut on a stop, whereby the extension of the first alignment device part 26 in the sawing direction 8 is shortened.

In FIG. 2, the saw aggregate 7 is shown in a lateral view, and in FIGS. 3a and 3b, the saw aggregate 7 is shown in a top view, wherein in FIG. 3a, the saw aggregate 7 is shown in a pivoted position 32 and in FIG. 3b, it is shown in the fixed position 33. The proportions in the figures FIGS. 3a and 3b are exaggerated here.

As is evident from FIGS. 2 and 3, the saw aggregate 7 has a saw aggregate frame 35, on which a rocker 36 is mounted so as to be pivotable about a pivot axis 37. The circular saw blade 6 is arranged on the rocker 36. By pivoting the rocker 36, the circular saw blade 6 can be pivoted into a sawing position 34, in which it protrudes through the sawing slot 5 and beyond the workpiece support 4 and thus serves to cut the workpiece support 2. By means of the rocker 36, the circular saw blade 6 can be pivoted downwards, so that it is arranged below the workpiece support 4 and thus can be displaced in the sawing direction 8 below the workpiece 2.

The circular saw blade 6 is mounted on the rocker so as to be rotatable about an axis of rotation 39, wherein the axis of rotation 39 is arranged at a distance A 38 from the pivot axis 37.

As is further apparent from FIG. 3, it may be provided that the rocker 36 is arranged on a longitudinal end opposite the pivot axis 37 and between a first clamping surface 40 and a second clamping surface 41. The clamping surfaces 40, 41 are coupled to the saw aggregate frame 35. In a first exemplary embodiment, it can be provided that the clamping surfaces 40, 41 are formed directly on the saw aggregate frame 35. In a further exemplary embodiment shown in FIG. 3, it may also be provided that the clamping surfaces 40, 41 are each formed on support pads, which are coupled to the saw aggregate frame 35.

Moreover, it may be provided that on the rocker 36, a first counter-clamping surface 42 is formed, which faces the first clamping surface 40, and a second counter-clamping surface 43 is formed, which faces the second clamping surface 41.

As is evident from FIG. 3a, in the pivoted position 32, the first counter-clamping surface 42 can be spaced apart from the first clamping surface 40 and the second counter-clamping surface 43 can be spaced apart from the second clamping surface 41. Thus, the rocker 36 can be pivoted freely about the pivot axis 37 In this regard, it may be provided that the rocker 36, seen in a top view, has a slight curvature, which is shown in an exaggerated manner in FIG. 3a for reasons of clarity. In order to transfer the rocker 36 from the pivoted position 32 into the fixed position 33, it may be provided that the second counter-clamping surface 43 is displaceable relative to the rocker 36 by means of an adjusting means 44. By means of the adjusting means 44, which acts between the rocker 36 and the second counter-clamping surface 43, the second counter-clamping surface 43 can be pressed onto the second clamping surface 41. As soon as the second counter-clamping surface 43 abuts on the second clamping surface 41, the rocker 36 is displaced or elastically deformed in the direction of the first clamping surface 40 until the first counter-clamping surface 42 also abuts on the first clamping surface 40. The rocker 36 is thus clamped between the first clamping surface 40 and the second clamping surface 41 and displaced into its fixed position 33. In particular, it may be provided that by this measure, the rocker 36 is deformed such that the previously mentioned curvature is pressed out of the rocker 36.

As is evident from FIG. 3, the circular saw blade 6 has a first second saw blade surface 45, a second saw blade surface 46 and a circumferential surface 47. Here, the first saw blade surface 45 and the second saw blade surface 46 are arranged opposite one another.

Furthermore, a vibration damping system 48 may be formed, which serves to damp axial vibrations of the circular saw blade 6. The vibration damping system 48 may comprise a force application device 49, which serves to apply a force acting in the axial direction to the circular saw blade 6.

The force application device 49 can for example be provided in the form of a compressed air nozzle, which can emit a compressed air blast onto the circular saw blade 6.

Alternatively to this, it may be provided that the force application device 49 is formed, for example, as an electromagnet, which serves to apply a magnetic force and/or a magnetic force impulse to the circular saw blade 6. The force application device 49 may be arranged on a side of the circular saw blade 6 as it is shown in FIG. 3. Alternatively to this, the force application device 49 may also be arranged on both sides of the circular saw blade 6.

The vibration damping system 48 can furthermore comprise a measuring system 50, which serves to detect the axial vibration amplitude of the circular saw blade 6. The measuring system 50 can for example be provided in the form of an inductive sensor.

FIG. 4 shows a detailed view of the workpiece support 4 in a sectional view. As is evident from FIG. 4, it may be provided that the workpiece support 4 is formed on a support plate 51, which may be produced for example from a plastic material in order to form a soft surface, so that the workpiece 2 is not scratched during the processing operation. In particular, it may be provided that the support plate 51 is arranged on a support plate holder 52, which is arranged on the machine base frame 3 or is coupled thereto. Thus, the support plate 51 can be arranged on the support plate holder 52 so as to be exchangeable. Furthermore, it may be provided that a compressed air nozzle 53 is formed, which is arranged in a through-bore 54 of the support plate 51. Multiple such compressed air nozzles 53 may be arranged spread across the support plate 51.

The compressed air nozzles 53 each can have a valve ball 55, which is pressed against a sealing surface by means of a spring and thus closes the compressed air nozzle 53 in the rest position. Only when placing the workpiece 2 on the workpiece support 4 and therefore pressing the valve ball 55 down against the spring force, an air stream through the compressed air nozzle 53 can be made possible.

Moreover, it may be provided that the compressed air nozzles 53 have a thread 56 and a mating thread 57 is formed in the support plate holder 52, into which the compressed air nozzles 53 can be screwed. The diameter of the through-bore 54 in the support plate 51 is preferably selected at such a size that the compressed air nozzle 53 can be freely accommodated in the support plate 51.

Moreover, it may be provided that in the support plate 51 a depression 58 is formed, which corresponds with an offset 59 on the compressed air nozzle 53. Due to this embodiment, the compressed air nozzle 53 can simultaneously serve to fix the support plate 51 on the support plate holder 52. Moreover, it may be provided that in the compressed air nozzle 53, screw-in recesses 60 are formed, which serve to screw the compressed air nozzle 53 into the support plate holder 52.

FIG. 5 shows a schematic presentation of the structure of the holding-down device 9 and the clamping device 13 in a perspective view. As is evident from FIG. 5, the first holding-down beam 10 has a first holding-down surface 61 and the second holding-down beam 11 has a second holding-down surface 62. The clamping device 13 has a clamping device frame 63, on which upper clamping fingers 64 and lower clamping fingers 65 are arranged. The lower clamping fingers 65 are not visible in FIG. 5. For positioning the workpiece 2, it is clamped between the upper clamping finger 64 and the lower clamping finger 65.

FIGS. 6 to 11 show the method sequence for positioning a workpiece 2, which on one side has only a small remaining size.

As is evident from FIG. 6, the workpiece 2 is displaced into its desired position in a first method step by means of the positioning device 12, in particular the clamping devices 13.

Optionally, a detection means 66 can be formed on the clamping device 13, which detection means 66 serves to detect the correct position of the workpiece 2. The detection means 66 can be provided for example in the form of a laser sensor, which can detect a distance between the workpiece 2 and a stop on the clamping device 13.

In a subsequent method step according to FIG. 7, the first holding-down beam 10 can be displaced downwards in the vertical direction 67, in order to get it closer to the workpiece 2. In particular, it may be provided here that the first holding-down surface 61 is positioned at a predefined distance from the workpiece 2.

Subsequently, individual pressure pins 68 arranged in the first holding-down beam 10 can be moved out of the first holding-down beam 10, as also evident from FIG. 7, in order to make them abut on the workpiece 2 and to thus roughly fix the workpiece 2 in place. The pressure pins 68 can be arranged in bores 69 in the first holding-down beam 10. In particular, it may be provided that the pressure pins 68 are preloaded in a retracted position 70 by means of a spring element and are displaced into an advance position 71, in which they abut on the workpiece 2, by means of compressed air.

When the workpiece 2 is fixed on the workpiece support 4 by means of the pressure pins 68, the upper clamping finger 64 can be lifted off the workpiece 2, as shown in FIG. 8, so that the clamping device 13 can be removed from the workpiece 2 as shown in FIG. 9. Alternatively to this, it is also conceivable that only the clamping force is removed and the upper clamping finger 64 is not lifted off the workpiece 2 completely.

In a subsequent method step, the second holding-down beam 11 can be moved in the vertical direction 67 toward the workpiece 2, as shown in FIG. 10, so that the second holding-down surface 62 is pressed onto the workpiece 2 and thus fixes the same in place on the workpiece support 4.

Simultaneously or in a subsequent method step, the first holding-down beam 10 can also be moved in the vertical direction 67 toward the workpiece 2, so that the first holding-down surface 61 is also made to abut on the workpiece 2. In this method step, the pressure pins 68 can be moved simultaneously into the first holding-down beam 10 into the retracted position 70, wherein the pressure pins 68 can apply a continuous pressure to the workpiece 2 while they are retracted.

As shown in FIG. 11, the workpiece 2 can be cut in a subsequent method step by means of the circular saw blade 6.

FIG. 12 shows the clamping device 13 in a perspective view, wherein a part of the clamping device frame 63 is not shown, in order to allow an insight into the parts located inside the clamping device 13.

In the exemplary embodiment according to FIG. 12, two upper clamping fingers 64 and two lower clamping fingers 65 are formed for each clamping device 13. The two lower clamping fingers 65 are each screwed directly to the clamping device frame 63 and thus are directly connected to it. Moreover, a lever 72 is provided, which is mounted on the clamping device frame 63 so as to be pivotable with respect to a first pivot axis 73. The upper clamping fingers 64 are arranged on the lever 72 so as to be distanced from the first pivot axis 73.

Moreover, a traction/pressure means 74 is formed, which on a second pivot axis 75 is coupled to the lever 72 and on a third pivot axis 76 is coupled to a second lever 77. In this regard, the second lever 77 is mounted on the clamping device frame 63 so as to be pivotable by means of a fourth pivot axis 78.

The fourth pivot axis 78 of the second lever 77 is arranged between a first longitudinal end 79 and a second longitudinal end 80 of the second lever 77. The third pivot axis 76 is arranged on the second longitudinal end 80 of the second lever 77. An actuator 81 is coupled to the first longitudinal end 79 of the second lever 77. In the present exemplary embodiment, the lever 72 and the second lever 77 are coupled to one another by means of the traction/pressure means 74, such that, upon the extension of the actuator 81, the lever 72 is pivoted such that the upper clamping fingers 64 are moved toward the lower clamping fingers 65 and thus, the workpiece 2 can be clamped.

FIG. 13 shows a schematic representation of a circular saw blade lubricating device 82. The circular saw blade lubricating device 82 has a nozzle holder 83, in which a slot 84 is formed. The slot 84 is formed such that the circular saw blade 6 can be accommodated in the slot 84. The slot 84 is particularly dimensioned at such a size that the circular saw blade 6 can be moved freely in the slot 84.

The slot 84 has a first lateral wall 85, a second lateral wall 86 and a rear wall 87. The first lateral wall 85 faces the first saw blade surface 45. The second lateral wall 86 faces the second saw blade surface 46. The rear wall 87 faces the circumferential surface 47.

In the first lateral wall 85, a first lubricant nozzle 88 is arranged. In the second lateral wall 86, a second lubricant nozzle 89 is arranged. In the rear wall 87, a third lubricant nozzle 90 is arranged.

In particular, it may be provided that the first lubricant nozzle 88 and the second lubricant nozzle 89 are formed so as to be located symmetrically opposite one another. Moreover, it may be provided that the first lubricant nozzle 88 and the second lubricant nozzle 89 are arranged at an angle 91 relative to the respective saw blade surface 45, 46 facing them.

Alternatively to this, the first lubricant nozzle 88 may be arranged so as to be offset to the second lubricant nozzle 89 in the radial direction of the circular saw blade.

The angle 91 is measured such that the lubricant nozzles 88, 89 have a spraying direction which faces the axis of rotation 39. In particular, it may be provided that the angle 91 is between 15° and 85°.

The third lubricant nozzle 90 is arranged in the nozzle holder 83 such that it serves to spray the circumferential surface 47 of the circular saw blade 6 with lubricant. In particular, it may be provided that the third lubricant nozzle 90 is arranged at an angle of 90° relative to the circumferential surface 47 of the circular saw blade 6.

The exemplary embodiments show possible embodiment variants, and it should be noted in this respect that the invention is not restricted to these particular illustrated embodiment variants of it, but that rather also various combinations of the individual embodiment variants are possible and that this possibility of variation owing to the teaching for technical action provided by the present invention lies within the ability of the person skilled in the art in this technical field.

The scope of protection is determined by the claims. However, the description and the drawings are to be adduced for construing the claims. Individual features or feature combinations from the different exemplary embodiments shown and described may represent independent inventive solutions. The object underlying the independent inventive solutions may be gathered from the description.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10. Finally, as a matter of form, it should be noted that for ease of understanding of the structure, elements are partially not depicted to scale and/or are enlarged and/or are reduced in size.

List of reference numbers

| | |
|---|---|
| 1 | panel saw |
| 2 | workpiece |
| 3 | machine base frame |
| 4 | workpiece support |
| 5 | sawing slot |
| 6 | circular saw blade |
| 7 | saw aggregate |
| 8 | sawing direction |
| 9 | holding-down device |
| 10 | first holding-down beam |
| 11 | second holding-down beam |
| 12 | positioning device |
| 13 | clamping device |
| 14 | positioning carriage |
| 15 | first linear guide |
| 16 | second linear guide |
| 17 | positioning direction |
| 18 | first drive motor |
| 19 | first drive system |
| 20 | second drive motor |
| 21 | second drive system |
| 22 | first absolute measuring system |
| 23 | second absolute measuring system |
| 24 | alignment device |
| 25 | suction |
| 26 | first alignment device part |
| 27 | second alignment device part |
| 28 | first stop |
| 29 | second stop |
| 30 | first side sawing slot |
| 31 | second side sawing slot |
| 32 | pivoted position |
| 33 | fixed position |
| 34 | sawing position |
| 35 | saw aggregate frame |
| 36 | rocker |
| 37 | rocker pivot axis |
| 38 | distance A |
| 39 | axis of rotation |
| 40 | first clamping surface |
| 41 | second clamping surface |
| 42 | first counter-clamping surface |
| 43 | second counter-clamping surface |
| 44 | adjusting means |
| 45 | first saw blade surface |
| 46 | second saw blade surface |
| 47 | circumferential surface |
| 48 | vibration damping system |
| 49 | force application device |
| 50 | measuring system |
| 51 | support plate |
| 52 | support plate holder |
| 53 | compressed air nozzle |
| 54 | through-bore |
| 55 | valve ball |
| 56 | thread |
| 57 | mating thread |
| 58 | depression |
| 59 | offset |
| 60 | screw-in recess |
| 61 | first holding-down surface |
| 62 | second holding-down surface |
| 63 | clamping device frame |
| 64 | upper clamping finger |
| 65 | lower clamping finger |
| 66 | detection means clamping device |
| 67 | vertical direction |
| 68 | pressure pin |
| 69 | bore for pressure pin |
| 70 | retracted position |
| 71 | advance position |
| 72 | lever |
| 73 | first pivot axis |
| 74 | traction/pressure means |
| 75 | second pivot axis |
| 76 | third pivot axis |
| 77 | second lever |
| 78 | fourth pivot axis |
| 79 | first longitudinal end second lever |
| 80 | second longitudinal end second lever |
| 81 | actuator |
| 82 | circular saw blade lubricating device |
| 83 | nozzle holder |
| 84 | slit |
| 85 | first lateral wall |
| 86 | second lateral wall |
| 87 | rear wall |
| 88 | first lubricant nozzle |
| 89 | second lubricant nozzle |
| 90 | third lubricant nozzle |
| 91 | angle |

1: A panel saw (1) for cutting workpieces (2) into multiple sections, comprising:
a machine base frame (3);
a workpiece support (4) with a sawing slot (5);
a saw aggregate (7), which is arranged below the workpiece support (4), wherein a circular saw blade (6) is arranged on the saw aggregate (7), which circular saw blade (6) in a sawing position (34) protrudes through the sawing slot (5) and is displaceable in a sawing direction (8);
a holding-down device (9) for clamping the workpiece (2) on the workpiece support (4);
a positioning device (12) for positioning the workpiece (2).

2: The panel saw (1) according to claim 1, wherein the saw aggregate (7) has a rocker (36), which is mounted on a saw aggregate frame (35) so as to be pivotable about a pivot axis (37), and wherein the circular saw blade (6) is mounted on the rocker (36) so as to be rotatable about an axis of rotation (39) at a distance A (38) from the pivot axis (37), wherein the rocker (36) at least in sections is arranged between a first clamping surface (40) and a second clamping surface (41), which are coupled to the saw aggregate frame (35) and are spaced apart from one another in the axial direction of the pivot axis (37), and on the rocker (36), a first counter-clamping surface (42) is formed, which faces the first clamping surface (40), and a second counter-clamping surface (43) is formed, which faces the second clamping surface (41), wherein, in a pivoted position (32), the first clamping surface (40) and the first counter-clamping surface (42) as well as the second clamping surface (41) and the second counter-clamping surface (43) are spaced apart from one another, and in a fixed position (33), the first clamping surface (40) and the first counter-clamping surface (42) as well as the second clamping surface (41) and the second counter-clamping surface (43) abut on one another.

3: The panel saw (1) according to claim 2, wherein the first clamping surface (40) is configured to be stationary relative to the saw aggregate frame (35), and that the first counter-clamping surface (42) is configured to be stationary relative to the rocker (36), and wherein the rocker (36) is configured to be flexible, so that the first counter-clamping surface (42) is movable in the direction toward the first clamping surface (40) and can be pressed against it in the fixed position (33).

4: The panel saw (1) according to claim 3, wherein the second clamping surface (41) is configured to be stationary relative to the saw aggregate frame (35), and wherein the second counter-clamping surface (43) is configured to be displaceable relative to the rocker (36), so that the rocker (36) can be transferred from the pivoted position (32) into the fixed position (33).

5: The panel saw (1) according to claim 1, wherein the holding-down device (9) has at least one first holding-down beam (10) with a first holding-down surface (61), wherein pressure pins (68), which are displaceable relative to the first holding-down surface (61), are arranged in the first holding-down beam (10).

6: The panel saw (1) according to claim 5, wherein the pressure pins (68) are arranged in bores (69) of the first holding-down surface (61) and are preloaded in their retracted position (70) by means of a spring element, and wherein the pressure pins (68) are displaceable out of their retracted position (70) and into an advance position (71) by means of compressed air.

7: The panel saw (1) according to claim 1, wherein the holding-down device (9) comprises the first holding-down beam (10) with the first holding-down surface (61) and a second holding-down beam (11) with a second holding-down surface (62), wherein the first holding-down beam (10) is arranged on a first side (30) of the sawing slot (5) and the second holding-down beam (11) is arranged on a second side (31) of the sawing slot (5), and wherein the two holding-down beams (10, 11) are displaceable independently of one another in the vertical direction (67).

8: The panel saw (1) according to claim 1, wherein the workpiece support (4) is formed on a support plate (51), which rests on a support plate holder (52), wherein compressed air nozzles (53) protrude through the support plate (51), wherein the compressed air nozzles (53) have a thread (56) and a mating thread (57) is formed in the support plate holder (52), and wherein the support plate (51) is affixed to the support plate holder (52) by means of the compressed air nozzles (53).

9: The panel saw (1) according to claim 8, wherein the support plate (51) has through-bores (54) for accommodating the compressed air nozzles (53), and wherein depressions (58) are formed in the through-bores (54), wherein the compressed air nozzles (53) have an offset (59), which corresponds to the depressions (58), so that the compressed air nozzles (53) are accommodated recessed in the support plate (51), and a fixing force can be applied to the support plate (51) by means of the offset (59) of the compressed air nozzles (53).

10: The panel saw (1) according to claim 1, wherein an alignment device (24) is formed, wherein the alignment device (24) is displaceable in the sawing direction (8).

11: The panel saw (1) according to claim 10, wherein at least parts of the alignment device (24) are telescopable in the sawing direction (8).

12: The panel saw (1) according to claim 10, wherein a suction (25) is arranged in the alignment device (24).

13: The panel saw (1) according to claim 10, wherein a stop (28, 29) is arranged on the front side of the alignment device (24).

14: The panel saw (1) according to claim 10, wherein the alignment device 24) is divided and a first alignment device part (26) is arranged on the first side (30) of the sawing slot (5) and a second alignment device part (27) is arranged on the second side (31) of the sawing slot (5).

15: The panel saw (1) according to claim 1, wherein a circular saw blade lubricating device (82) is formed, which has a nozzle holder (83) having a slot (84) for accommodating the circular saw blade (6), wherein a first lubricant nozzle (88) is arranged in a first lateral wall (85) of the slot (84) and a second lubricant nozzle (89) is arranged in a second lateral wall (86) of the slot (84).

16: The panel saw (1) according to claim 15, wherein the first lubricant nozzle (88) and the second lubricant nozzle (89) are arranged at an angle (91) of 15° to 85° relative to the respective saw blade surface (45, 46) facing them.

17: The panel saw (1) according to claim 15, wherein a third lubricant nozzle (90) is arranged on a rear wall (87) of the slot (84), which third lubricant nozzle (90) is directed toward a circumferential surface (47) of the circular saw blade (6).

18: The panel saw (1) according to claim 1, wherein the positioning device (12) comprises at least one clamping device (13), wherein the clamping device (13) comprises a clamping device frame (63), at least one lower clamping finger (65), one upper clamping finger (64) and a lever (72), on which the upper clamping finger (64) is arranged, wherein the lever (72) is mounted on the clamping device frame (63) so as to be pivotable with respect to a first pivot axis (73), and wherein, between the first pivot axis (73) and the upper clamping finger (64), a traction/pressure means (74) is coupled to the lever (72) so as to be pivotable with respect to a second pivot axis (75), wherein the traction/pressure means (74) is coupled to an actuator (81), in particular a cylinder, such that when extending the actuator (81), the upper clamping finger (64) is moved toward the lower clamping finger (65).

19: The panel saw (1) according to claim 18, wherein the clamping device (13) has a second lever (77), which is mounted on the clamping device frame (63) so as to be pivotable about a fourth pivot axis (78), wherein the second lever (77) at a first longitudinal end (79) is coupled to the actuator (81) and at a second longitudinal end (80) is coupled to the traction/pressure means (74), and wherein the fourth pivot axis (78) is arranged between the first longitudinal end (79) and the second longitudinal end (80), in particular wherein the traction/pressure means (74) is coupled to the second lever (77) such that the traction/pressure means (74) is subjected to tension when the actuator (81) extends.

20: The panel saw (1) according to claim 18, wherein a detection means (66) is formed, which serves to detect the position of the workpiece (2) in the clamping device (13).

21: The panel saw (1) according to claim 1, wherein the positioning device (12) comprises a positioning carriage (14), on which multiple clamping devices (13) are arranged, wherein the positioning carriage (14) is mounted on the machine base frame (3) so as to be displaceable on a first linear guide (15) and on a second linear guide (16), wherein a first drive motor (18) is coupled to a first drive system (19) in the region of the first linear guide (15), and a second drive motor (20) is coupled to a second drive system (21) in the region of the second linear guide (16).

22: The panel saw (1) according to claim 21, wherein a first absolute measuring system (22) is formed in the region of the first linear guide (15), which first absolute measuring system (22) serves to provide a position information to the first drive motor (18), and a second absolute measuring system (23) is formed in the region of the second linear guide (16), which second absolute measuring system (23) serves to provide a position information to the second drive motor (20).

23: The panel saw (1) according to claim 1, wherein the first linear guide (15) and the second linear guide (16) of the positioning carriage (14) are arranged below the level of the workpiece support (4).

24: The panel saw (1) according to claim 1, wherein a vibration damping system (48) is formed on the saw aggregate (7), which vibration damping system (48) has a force application device (49) for applying force to the circular saw blade (6) in a contactless manner.

25: The panel saw (1) according to claim 24, wherein the force application device (49) has a fluid nozzle, by means of which a pressure surge can be emitted, in particular by means of compressed air, onto the circular saw blade (6), or wherein the force application device (49) has an electromagnet, by means of which a magnetic force impulse can be emitted onto the circular saw blade (6).

26: The panel saw (1) according to claim 1, wherein a light strip, in particular an LED strip, is arranged in the region of the holding-down device (9).

27: A method for operating the panel saw (1) according to claim 1, wherein the method comprises the following method steps:
placing a workpiece (2) onto the workpiece support (4);
positioning the workpiece (2) by means of a positioning device (12);
cutting the workpiece (2) by means of the circular saw blade (6) by displacing the saw aggregate (7) in the sawing direction (8).

28: The method according to claim 27, wherein for cutting an end section of the workpiece (2), the following method steps are performed:
positioning the workpiece (2) by means of the positioning device (12);
lowering the first holding-down beam (10);
moving the pressure pins (68) out of the first holding-down surface (61) of the first holding-down beam (10) until the pressure pins (68) press the workpiece (2) onto the workpiece support (4), wherein particularly the pressure pins (68) between the upper clamping fingers (64) press against the workpiece (2);
opening the upper clamping finger (64) of the clamping device (13) of the positioning device (12);
removing the positioning device (12) from the workpiece (2);
lowering the first holding-down beam (10) and the second holding-down beam (11) until the first holding-down surface (61) of the first holding-down beam (10) and the second holding-down surface (62) of the second holding-down beam (11) abut on the workpiece (2);
cutting the workpiece (2) by means of the circular saw blade (6) by displacing the saw aggregate (7) in the sawing direction.

29: The method according to claim 27, wherein for cutting an start section of the workpiece (2), the following method steps are performed:
positioning the workpiece (2) by means of the positioning device (12);
displacing the first alignment device part (26) and the second alignment device part (27) toward the workpiece (2) until the second stop (29) of the second alignment device part (27) abuts on the workpiece (2);
lowering the first holding-down beam (10) and the second holding-down beam (11) until the first holding-down surface (61) of the first holding-down beam (10) and the second holding-down surface (62) of the second holding-down beam (11) abut on the workpiece (2);
cutting the workpiece (2) by means of the circular saw blade (6) by displacing the saw aggregate (7) in the sawing direction (8) while simultaneously displacing the first alignment device part (26) along with the saw aggregate (7).

30: The method according to claim 27, wherein when cutting the workpiece (2) by means of the circular saw blade (6), the vibration amplitude of the circular saw blade (6) in the axial direction is detected by a measuring system (50), and the circular saw blade (6) is subjected to force impacts by the force application device (49), such that the vibration amplitude of the circular saw blade (6) is counteracted.

31: The method according to claim 27, wherein when positioning the workpiece (2) by means of the positioning device (12), the first drive motor (18)) and the second drive motor (20) are operated synchronously, wherein the detection value of the first absolute measuring system (22) and of the second absolute measuring system (23) flows into the control as a control variable.
